(19) United States
(12) Patent Application Publication
(10) Pub. No.: US 2026/0274341 A1
(43) Pub. Date: Sep. 17, 2026

(54) FRONT ARRANGEMENT FOR VEHICLE AND ASSOCIATED VEHICLE

(71) Applicant: FLEXIS, BOULOGNE-BILLANCOURT (FR)

(72) Inventor: Michael CAUDRON, VILLIERS SAINT-FREDERIC (FR)

(21) Appl. No.: 19/560,654

(22) Filed: Mar. 9, 2026

(30) Foreign Application Priority Data
Mar. 11, 2025 (FR) FR2502407

(51) Int. Cl. B62D 21/18; B60H 1/32; B60K 1/04; B62D 21/03

(52) U.S. Cl. CPC B62D 21/18; B60H 1/3229; B60K 1/04; B62D 21/03

(57) ABSTRACT

A front arrangement for a vehicle includes: a subframe including two side members, each of the two side members extends according to a longitudinal direction between a front end and a rear end, the two side members are spaced apart from one another according to a transverse direction; a support including an upper face and a lower face opposite one another according to a vertical direction perpendicular to the longitudinal direction and to the transverse direction, the lower face of the support extends facing the subframe; a lower receiving space defined according to the vertical direction between the lower face of the support and the subframe; and a charger fixed to the subframe and extending into the lower receiving space.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a front arrangement for a vehicle, in particular intended to be arranged at the front of a vehicle. The present disclosure also relates to a vehicle, notably a motor vehicle, comprising such a front arrangement.

### BACKGROUND

Commercial vehicles, notably light ones such as vans, are increasingly used, in particular, in cities, for example to ensure the delivery of parcels and/or goods.

For functional reasons, such vehicles generally have large dimensions, notably at the front of the vehicle.

Thus, such vehicles often present a large front overhang and a large turning diameter.

Known commercial vehicles are therefore generally not very maneuverable, which causes difficulties, in particular in narrow urban spaces.

### SUMMARY

One of the aims of the present disclosure is then to overcome these drawbacks, and in particular to propose a front arrangement for a vehicle allowing to improve the maneuverability of the vehicle.

To this end, the present disclosure has as its object a front arrangement for a vehicle, notably for a motor vehicle, comprising:
a subframe comprising two side members, each of the side members extending according to a longitudinal direction between a front end and a rear end, the two side members being spaced apart from one another according to a transverse direction perpendicular to the longitudinal direction,
a support comprising an upper face and a lower face opposite one another according to a vertical direction perpendicular to the longitudinal direction and to the transverse direction, the lower face of the support extending facing the subframe,
a lower receiving space defined according to the vertical direction between the lower face of the support and the subframe, and
a charger fixed to the subframe and extending in the lower receiving space.

According to other advantageous aspects of the present disclosure, the front arrangement comprises one or more of the following features, taken alone or according to all technically possible combinations:
The subframe comprises a crossmember extending between the two side members according to the transverse direction, the charger being fixed to said crossmember.
The front arrangement further comprises a battery fixed on the upper face of the support.
The front arrangement further comprises an air-conditioning compressor fixed on the upper face of the support.
The air-conditioning compressor comprises a U-shaped filter support.
The front arrangement comprises a solenoid valve fixed to the lower face of the support.
The front arrangement comprises a cooling and/or a heating element, the cooling and/or the heating element being fixed to the lower face of the support.
The front arrangement further comprises at least one line of an air-conditioning and/or heating system of the vehicle, the line extending at least partially in the lower receiving space.

The present disclosure also relates to a vehicle, in particular, a motor vehicle, comprising a front arrangement as described above.

According to another advantageous aspect of the present disclosure, the vehicle further comprises a powertrain arranged at the rear of the vehicle.

### BRIEF DESCRIPTION OF THE DRAWINGS

The present disclosure will appear more clearly on reading the following description, given solely by way of a non-limiting example, and made with reference to the drawings in which:

FIG. 1 is a schematic view of a vehicle according to the present disclosure,

FIG. 2 is a schematic view of a front arrangement according to the present disclosure, the arrangement comprising a subframe and a support carrying components,

FIGS. 3 and 4 are sectional views of the front arrangement of FIG. 2,

FIG. 5 is a perspective view of an example of a support carrying components of a front arrangement according to the present disclosure,

FIG. 6 is a perspective view of an example of a subframe of a front arrangement according to the present disclosure, and

FIG. 7 is a perspective view of an example of a compressor of a front arrangement according to the present disclosure.

### DETAILED DESCRIPTION

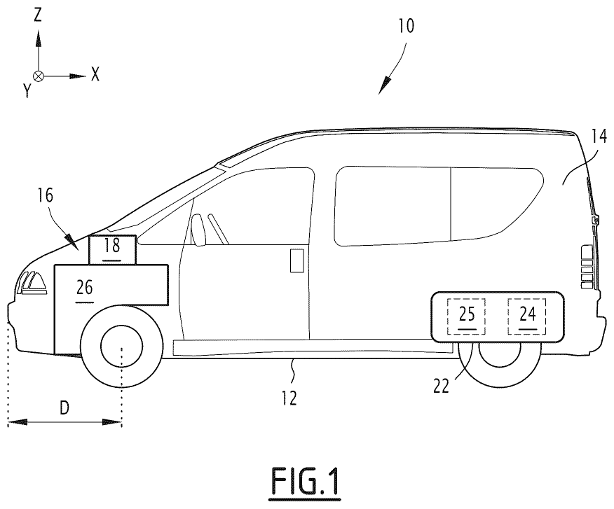

FIG. 1 shows a vehicle 10 according to the present disclosure.

The vehicle 10 is for example a motor vehicle, in particular a commercial vehicle, notably a light commercial vehicle.

In particular, the vehicle 10 is intended to transport goods, such as parcels, and/or passengers.

The vehicle 10 is for example a van, as illustrated in FIG. 1.

The vehicle 10 is preferably an electric vehicle.

For clarity, an orthonormal reference frame XYZ is defined comprising a longitudinal direction X, a transverse direction Y and a vertical direction Z. The longitudinal direction X extends according to the forward travel axis of the vehicle 10 and corresponds to a front-rear axis of the vehicle 10. The transverse direction Y is perpendicular to the longitudinal direction X and corresponds to a left-right axis of the vehicle 10. The vertical direction Z is perpendicular to the longitudinal direction X and to the transverse direction Y and corresponds to a bottom-top axis of the vehicle 10.

The terms “top” and “bottom” are defined relative to the vertical direction Z corresponding to the height of the vehicle. The terms “left”, “right”, “front” and “rear” are defined relative to the usual direction of forward travel of the vehicle.

For example, the vehicle 10 comprises a chassis 12, notably of the “skateboard platform” type, and a body 14 fixed on the chassis 12.

In particular, the chassis 12 for example, comprises a flat structure, resembling a skateboard, and intended to support all the essential mechanical and electronic components for propulsion and control of the vehicle.

The vehicle 10 advantageously presents a small front overhang, corresponding to the distance D between the axis of a front wheel of the vehicle 10 and a front end of the vehicle 10. For example, the overhang is between 600 and 900 mm and is, for example, substantially equal to 750 mm.

The vehicle 10 advantageously also presents a small turning diameter, corresponding in particular to the diameter of the smallest circle that the vehicle can describe by turning its wheels to the maximum. For example, the turning diameter of the vehicle 10 is between 7 m and 12 m and is for example substantially equal to 10 m.

The vehicle 10 advantageously also presents a long wheelbase, corresponding in particular to the distance between the front and rear axles. For example, the wheelbase of the vehicle 10 is between 3000 mm and 3500 mm.

Preferably, the vehicle 10, and in particular the body 14, defines a compartment 16, notably at the front of the vehicle 10.

Advantageously, the vehicle 10 comprises a heating and/or cooling system 18, in particular intended to heat and/or cool the passenger compartment of the vehicle 10 and/or other elements of the vehicle 10, such as high-voltage components for example.

The heating and/or cooling system 18 is preferably arranged in the compartment 16.

The heating and/or cooling system 18 is for example a heat pump.

Preferably, the vehicle 10 comprises a powertrain 22 arranged at the rear of the vehicle 10.

In particular, the powertrain 22 for example, comprises a motor 24, notably electric. The motor 24 is for example fixed to the chassis 12, and in particular to the rear of the chassis 12.

Preferably, the powertrain 22 also comprises a traction battery 25, in particular arranged near the motor 24.

The vehicle 10 comprises a front arrangement 26 according to the present disclosure.

As is visible in FIG. 1, the front arrangement 26 is, in particular, arranged at the front of the vehicle 10, and notably in the compartment 16.

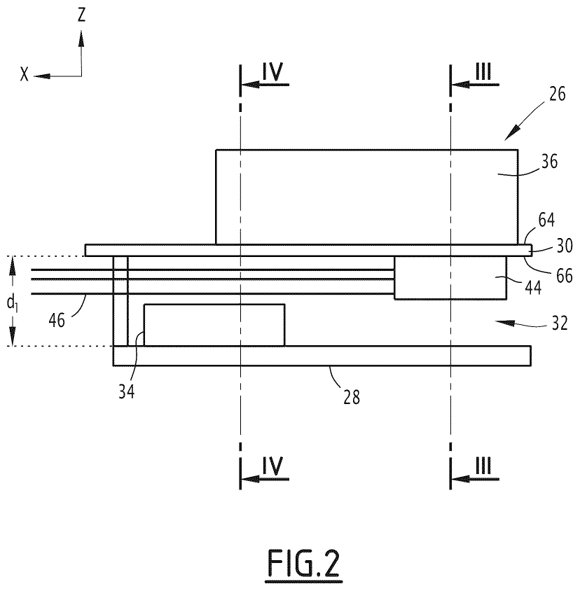

As illustrated in FIG. 2, the front arrangement 26 comprises a subframe 28, a support 30, a lower receiving space 32 and a charger 34.

Preferably, the front arrangement 26 further comprises at least one from among a battery 36, an air-conditioning compressor 38, a solenoid valve 40, a cooler 42, a heating element 44 and at least one line 46 of the heating and/or cooling system 18 of the vehicle 10.

The subframe 28 comprises two side members 48A,48B, and preferably at least one crossmember 50.

The two side members 48A,48B each extend according to the longitudinal direction X between a front end 54A, 54B and a rear end 56A, 56B.

The two side members 48A, 48B are spaced apart from one another according to the transverse direction Y.

In particular, the subframe 28 comprises a left side member 48A and a right side member 48B.

Each of the two side members 48A, 48B presents, for example, a beam, notably metallic, for example in steel or an aluminum alloy.

Each of the two side members 48A, 48B presents, for example, a closed box section, notably of substantially square shape, in particular with a side between 3 cm and 15 cm.

Preferably, the crossmember 50 extends between the two side members 48A, 48B according to the transverse direction Y.

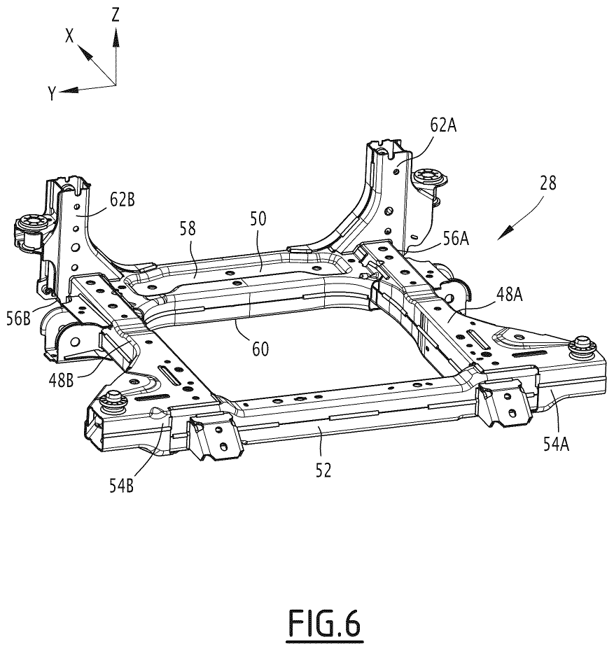

In particular, in the particular embodiment illustrated in FIG. 6, the crossmember 50 extends, and notably connects, the rear ends 56A, 56B of the two side members 48A, 48B.

The crossmember 50 is for example made of metal, notably in steel or an aluminum alloy.

The crossmember 50 presents, for example, a closed box section, notably of rectangular shape, for example with a length (measured according to the direction X) between 7 cm and 20 cm.

In particular, the crossmember 50 preferably comprises an upper face 58 and a lower face 60 opposite one another according to the vertical direction Z. Each of the two faces 58,60 extends notably in a plane XY.

Each of the two faces 58,60 extends, notably, substantially in a plane XY. For example, the upper face 58 is oriented upward and the lower face 60 downward.

Advantageously, the subframe 28 also comprises a front crossmember 52, in particular to reinforce said subframe 28.

For example, in the particular embodiment illustrated in FIG. 6, the front crossmember 52 extends, and notably connects, the front ends 54A, 54B of the two side members 48A, 48B.

In a particular embodiment, the subframe 28 comprises two lugs 62A, 62B for fastening suspension elements, and notably, a left lug 62A and a right lug 62B.

As is visible in FIG. 6, each of the lugs 62A, 62B extends according to the vertical direction Z.

For example, each of the lugs 62A, 62B is fixed to the rear end 56A, 56B of the corresponding side member 48A, 48B.

For example, the subframe 28 is fixed to the chassis 12, and notably, to the front thereof.

In particular, the rear ends 56A, 56B of the side members 48A, 48B are for example connected to the front of the chassis 12.

Alternatively, the subframe 28 is an integrated subframe, in other words, it forms an integral part of the chassis 12.

The support 30 comprises an upper face 64 and a lower face 66 opposite one another according to the vertical direction Z.

Each of the two faces 64, 66 extends notably, substantially in a plane XY. For example, the upper face 64 is oriented toward the top and the lower face 66 toward the bottom.

As is visible in FIGS. 2 to 4, the lower face 66 of the support 30 extends facing the subframe 28, notably according to the vertical direction Z.

For example, the lower face 66 of the support 30 extends parallel to the subframe 28 and preferably at a distance therefrom according to the vertical direction Z.

In particular, the lower face 66 of the support 30 is at a distance d1 from the subframe 28, and, for example, from the upper face 58 of the crossmember 50, between 2 cm and 100 cm.

For example, the support 30 comprises, and is preferably formed by, a sheet metal part 68 defining the upper face 64 and the lower face 66.

The sheet metal part 68 is for example folded and/or stamped.

For example, the sheet metal part 68 is made of steel.

The sheet metal part 68 presents, for example, a thickness between 1 mm and 2 mm, or even between 1.5 mm and 1.75 mm.

The sheet metal part 68 presents, for example, a section, notably taken in the plane XZ, in the shape of an inverted omega.

In particular, the sheet metal part 68 defines two transverse edges 70, connected to one another by a central portion 72.

Each of the transverse edges 70 extends notably according to the transverse direction Y.

For example, each of the transverse edges 70 presents a section in the shape of an inverted U, notably oriented toward the bottom.

The central portion 72 extends, in particular, in a plane XY between the two transverse edges 70.

Advantageously, the support 30 comprises recesses and/or bosses, in particular, provided in the central portion 72 and/or the transverse edges 70 of the sheet metal part 68.

The support 30 is for example fixed to the chassis 12, and notably, to the front thereof.

The support 30 presents for example a length, measured according to the transverse direction Y, between 650 mm and 850 mm, or even between 730 mm and 780 mm.

The support 30 presents for example a width, measured according to the longitudinal direction X, between 200 mm and 350 mm, or even between 250 mm and 300 mm.

The lower receiving space 32 is defined according to the vertical direction Z between the lower face 66 of the support 30 and the subframe 28.

In particular, the lower receiving space 32 corresponds to the volume defined between the lower face 66 of the support 30 and the subframe 28, notably with the height d1.

The charger 34 is fixed to the subframe 28.

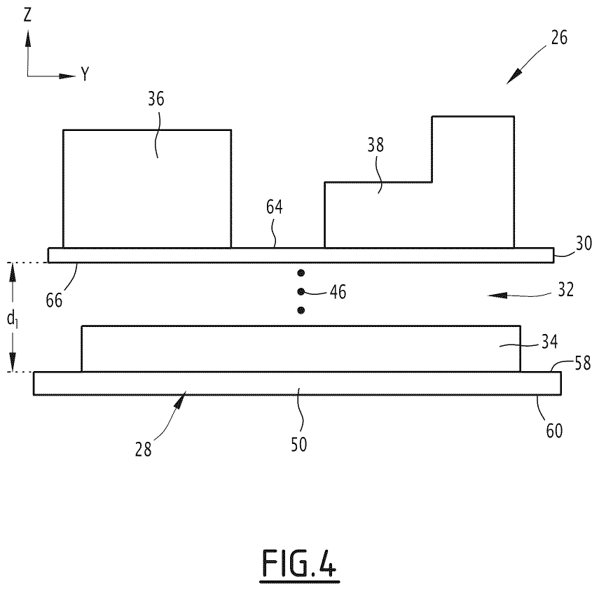

As is visible in FIGS. 2 and 4, the charger 34 extends in the lower receiving space 32.

More precisely, in one particular embodiment, the charger 34 is fixed to the crossmember 50, and notably to the upper face 58 of the crossmember 50.

The charger 34 is, for example, fixed to the subframe 28 by screws.

The charger 34 presents, for example, a rectangular block shape.

The charger 34 is, for example, intended to convert electrical energy coming from an external source, such as a wall socket or a charging station, into energy stored in the traction battery 25.

Preferably, the battery 36 is fixed on the upper face 64 of the support 30, and notably on the central portion 72 of the sheet metal part 68, for example by screws.

The battery 36 is for example fixed on the right side of the upper face 64 of the support 30.

The battery 36 preferably comprises a protective part 74, in particular surrounding the battery 36.

The protective part 74 is advantageously configured to protect the battery 36 in the event of an accident, and in particular, a front collision.

The battery 36 is for example an auxiliary battery, notably lead-acid.

The battery 36 presents, notably a terminal voltage of the order of 12 Volts.

Preferably, the air-conditioning compressor 38 is fixed on the upper face 64 of the support 30, and notably on the central portion 72 of the sheet metal part 68, for example by screws.

The air-conditioning compressor 38 is, for example, fixed on the left side of the upper face 64 of the support 30, in particular next to the battery 36.

The air-conditioning compressor 38, in particular, comprises a main body 76.

The air-conditioning compressor 38, and notably its main body 76, is preferably an electric air-conditioning compressor supplied with high voltage, for example of the order of 800 V, and notably without a belt.

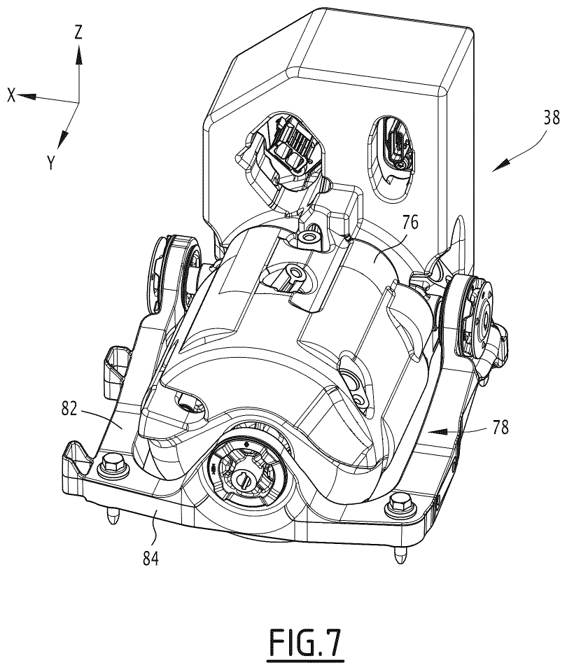

As is visible in FIG. 7, the air-conditioning compressor 38 advantageously further comprises a filter support 78, and notably a filtration means.

The filter support 78 preferably ensures fastening of the air-conditioning compressor 38 onto the upper face 64 of the support 30, and more precisely in one of the recesses provided on the support 30, and even more precisely provided on the central portion 72 of the sheet metal part 68.

In particular, the filter support 78 is fixed between the main body 76 and the support 30.

The filter support 78 presents, for example, a U shape, notably in the plane XY.

More particularly, the filter support 78 comprises two transverse branches 82 each extending according to the transverse direction Y and connected to one another by a longitudinal branch 84 extending according to the longitudinal direction X.

The filter support 78 is for example made of an aluminum alloy, and notably by casting.

The filtration means is advantageously arranged between the filter support 78 and the main body 76, in particular so as not to transmit vibrations coming from the main body 76 to the support 30.

The filtration means is preferably configured so as to ensure pendular damping, notably at its center of gravity.

Preferably, the cooler 42 is fixed on the lower face 66 of the support 30, for example by screws.

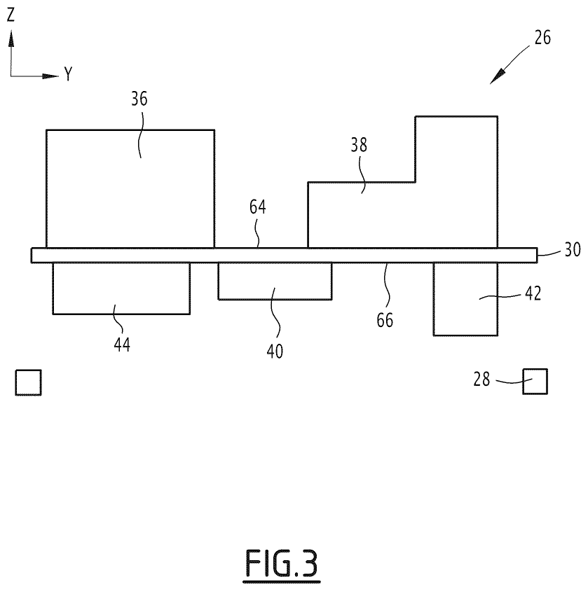

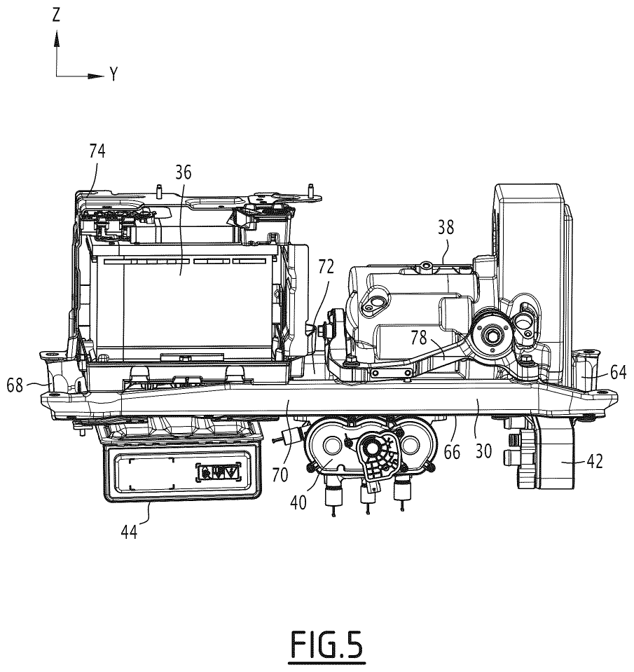

The cooler 42 is, for example, fixed on the left side of the lower face 66 of the support 30, as is visible in FIGS. 3 and 5.

The cooler 42 is for example a component of the heating and/or cooling system 18.

For example, the cooler 42 is more commonly known as a “Chiller”.

More particularly, the cooler 42 is configured to provide heat exchange between a liquid, notably water, and a gas, notably air, used in the heating and/or cooling system 18.

Preferably, the heating element 44 is fixed on the lower face 66 of the support 30, for example by screws.

The heating element 44 is, for example, fixed on the right side of the lower face 66 of the support 30, as is visible in FIGS. 3 and 5.

The heating element 44 is for example a component of the heating and/or cooling system 18.

For example, the heating element 44 is notably of the HVCH type (for “High Voltage Coolant Heaters”).

More particularly, the heating element 44 is configured to heat the liquid, notably water, of the heating and/or cooling system 18, for example by means of a heating resistor.

The solenoid valve 40 is fixed on the lower face 66 of the support 30, for example by screws.

The solenoid valve 40 is for example fixed in the middle of the lower face 66 of the support 30, notably between the cooler 42 and the heating element 44, as is visible in FIGS. 3 and 5.

The solenoid valve 40 is for example a component of the heating and/or cooling system 18.

For example, the solenoid valve 40 is provided with seven ports.

More particularly, the solenoid valve 40 is configured to ensure distribution of the cooling and/or heating liquid, notably water, to different members, for example cooling of the traction battery 25 and/or of the electric motor 24 and/or of the passenger compartment of the vehicle 10.

Advantageously, the front arrangement 26 comprises a plurality of lines 46 of the heating and/or cooling system 18.

Preferably, at least one, and advantageously each of the lines 46 extends at least partially in the lower receiving space 32.

In particular, each of the lines 46 is configured to ensure transport of the cooling and/or heating liquid in the vehicle 10, notably toward the different members, such as the traction battery 25 and/or the electric motor 24 and/or the passenger compartment of the vehicle 10.

The lines 46 are for example connected to the solenoid valve 40 and/or the cooler 42 and/or the heating element 44.

The heating and/or cooling system 18 of the vehicle 10 notably comprises other components, such as a degassing tank and/or at least one pump for example.

Such a front arrangement 26 is particularly advantageous.

In particular, such a front arrangement 26 presents the advantage of being compact, notably thanks to the support 30.

Furthermore, the arrangement of the various components 34,36,38,40,42,44,46 on the support 30, on the subframe 28, and notably in the receiving space 32, allows a compact arrangement of these components.

Moreover, the arrangement of the powertrain 22 at the rear of the vehicle 10 makes the front of the vehicle 10 even more compact.

This compactness of the front of the vehicle 10 thus allows to reduce the front overhang and the turning diameter, which thus improves the maneuverability of the vehicle 10.

Furthermore, thanks to the front arrangement 26 comprising all of the components arranged vertically, the functionalities of the vehicle 10 are not reduced and in particular, the wheelbase of the vehicle 10 is not affected.

What is claimed is:

1. A front arrangement for a vehicle comprising:
a subframe comprising two side members, each of the two side members extending according to a longitudinal direction between a front end and a rear end, the two side members being spaced apart from one another according to a transverse direction perpendicular to the longitudinal direction;
a support comprising an upper face and a lower face opposite one another according to a vertical direction perpendicular to the longitudinal direction and to the transverse direction, the lower face of the support extending facing the subframe;
a lower receiving space defined according to the vertical direction between the lower face of the support and the subframe; and
a charger fixed to the subframe and extending in the lower receiving space.

2. The front arrangement according to claim 1, wherein the subframe comprises a crossmember extending between the two side members according to the transverse direction, the charger being fixed to said crossmember.

3. The front arrangement according to claim 1, further comprising a battery fixed on the upper face of the support.

4. The front arrangement according to claim 1, further comprising an air-conditioning compressor fixed on the upper face of the support.

5. The front arrangement according to claim 4, wherein the air-conditioning compressor comprises a U-shaped filter support.

6. The front arrangement according to claim 1, comprising a solenoid valve fixed to the lower face of the support.

7. The front arrangement according to claim 1, comprising a cooler and/or a heating element, the cooler and/or the heating element being fixed to the lower face of the support.

8. The front arrangement according to claim 1, further comprising at least one line of an air-conditioning and/or heating system of the vehicle, the at least one line extending at least partially into the lower receiving space.

9. A vehicle comprising the front arrangement according to claim 1.

10. The vehicle according to claim 9, further comprising a powertrain arranged at a rear of the vehicle.
